(19) United States
(12) Patent Application Publication
(10) Pub. No.: US 2009/0300661 A1
(43) Pub. Date: Dec. 3, 2009

(54) Installer System and Installer Program

(75) Inventor: Norihiko ASAI, Tajimi-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 12/412,903

(22) Filed: Mar. 27, 2009

(30) Foreign Application Priority Data
May 28, 2008 (JP) 2008-139343

(51) Int. Cl. G06F 9/44

(52) U.S. Cl. 719/327

(57) ABSTRACT

An installer system, includes: a detection unit configured to detect at least one device driver having been installed in a computer, in response to an installation instruction to install a device driver to be installed; an output unit configured to set at least one of the device driver detected by the detection unit as at least one device driver to be uninstalled and configured to output a screen for displaying information on the device driver to be uninstalled, the screen to which an uninstallation instruction can be input; and an uninstaller unit configured to uninstall the device driver to be uninstalled in response to the uninstallation instruction.

### CROSS-REFERENCE TO RELATED APPLICATION

This application claims priority from Japanese Patent Application No. 2008-139343, filed on May 28, 2008, the entire subject matter of which is incorporated herein by reference.

### TECHNICAL FIELD

Aspects of the invention relate to an installer system and an installer program for installing a device driver. More particularly, aspects of the invention relate to an installer system and an installer program capable of managing an installed device driver.

### BACKGROUND

Device drivers for printers or scanners are installed in an information processing apparatus such as a personal computer (PC). An installer is utilized to install a new device driver in the PC. An uninstaller is utilized to remove an installed device driver from the PC. Information on the installed device driver is recorded in a database (for example, a registry in a Windows (registered trademark) OS) in an operating system (OS). The related art of installing or uninstalling a device driver is disclosed, for example, in JP-A-2004-295181.

However, the related-art installer system has the following problem. When plural devices are used, a user has to install device drivers corresponding to the devices. On the other hand, the user has to uninstall device drivers corresponding to the devices which became not in use. When the user neglects the uninstallation, the number of drivers installed in the PC increases and the choice for use of a device becomes various. Accordingly, the operability is deteriorated.

### SUMMARY

Exemplary embodiments of the present invention address the above disadvantages and other disadvantages not described above. However, the present invention is not required to overcome the disadvantages described above, and thus, an exemplary embodiment of the present invention may not overcome any of the problems described above.

Accordingly, it is as aspect of the present invention to provide an installer system and an installer program with improved operability in using a device.

According to the above and other aspects of the invention, there is provided an installer system comprising: a detection unit configured to detect at least one device driver having been installed, in a computer in response to an installation instruction to install a device driver to be installed; an output unit configured to set at least one of the device driver detected by the detection unit as at least one device driver to be uninstalled, and configured to output a screen for displaying information on the device driver to be uninstalled, the screen to which an uninstallation instruction can be input; and an uninstaller unit configured to uninstall the device driver to be uninstalled in response to the uninstallation instruction.

According to the above and other aspects of the invention, there is also provided an installer system, comprising: a detection unit configured to detect at least one device driver having been installed in a computer, in response to an instruction to install a device driver to be installed; an extraction unit configured to extract at least one device driver from the device drivers detected by the detection unit, under a condition; and an automatic uninstaller unit configured to uninstall the device driver extracted by the extraction unit.

According to the above and other aspects of the invention, there is also provided a computer-readable medium having a computer program stored therein and readable by a computer, the computer program, when executed by the computer, causing the computer to perform operations comprising: detecting at least one device driver having been installed in the computer, in response to an installation instruction to install a device driver to be installed; setting at least one of the device driver detected by the detection unit as at least one device driver to be uninstalled; outputting a screen for displaying information on the device driver to be uninstalled, the screen to which an uninstallation instruction can be input; and uninstalling the device driver to be uninstalled in response to the uninstallation instruction.

According to the above and other aspects of the invention, there is also provided a computer-readable medium having a computer program stored therein and readable by a computer, the computer program, when executed by the computer, causing the computer to perform operations comprising: detecting at least one device driver having been installed in the computer, in response to an instruction to install a device driver to be installed; extracting at least one device driver from the device drivers detected by the detection unit, under a condition; and uninstalling the device driver extracted by the extraction unit.

### BRIEF DESCRIPTION OF THE DRAWINGS

The above and other aspects of the present invention will become more apparent and more readily appreciated from the following description of exemplary embodiments of the present invention taken in conjunction with the attached drawings, in which:

FIG. 1 is a block diagram illustrating a configuration of an installer system according to an embodiment of the invention;

FIG. 2 is a block diagram illustrating details of a PC in the installer system according to the embodiment;

FIG. 3 is a diagram illustrating an example of a database storing a print history;

FIG. 4 is a diagram illustrating an example of a database storing a default history;

FIG. 5 is a flowchart illustrating a procedure of operations of an installer according to a first embodiment of the invention;

FIG. 6 is a diagram illustrating an example of a selection screen for selecting a printer to be uninstalled;

FIG. 7 is a flowchart illustrating a procedure of operations of an installer according to a second embodiment of the invention;

FIG. 8 is a flowchart illustrating a procedure of operations of an installer according to a third embodiment of the invention; and

FIG. 9 is a flowchart illustrating a procedure of operations of an installer according to a fourth embodiment of the invention.

### DETAILED DESCRIPTION

Hereinafter, a device managing system and a program according to an embodiment of the invention will be described with reference to the accompanying drawings. In this embodiment, the invention is applied to a device managing system and a program including printers as devices and a PC as a controller thereof and managing a default device set in the PC.

(System Configuration)

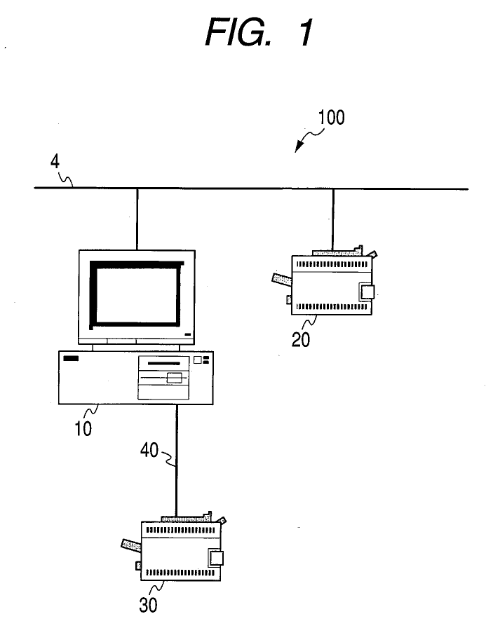

As shown in FIG. 1, a device managing system 100 according to an embodiment of the invention includes a PC 10 and printers 20 and 30. In the system 100, the PC 10 and the printer 20 are connected to each other through a network 4 such as a LAN. The PC 10 and the printer 30 are connected directly to each other through a printer cable 40.

As shown in FIG. 1, the PC 10 can use plural printers. That is, printer drivers for usable printers are installed in the PC 10 and the PC 10 can output printing commands to the printers. The PC 10 is connected to the printers 20 and 30 in FIG. 1, but the PC 10 may be connected to other printers than the printers 20 and 30. Plural printer drivers are installed in the PC 10.

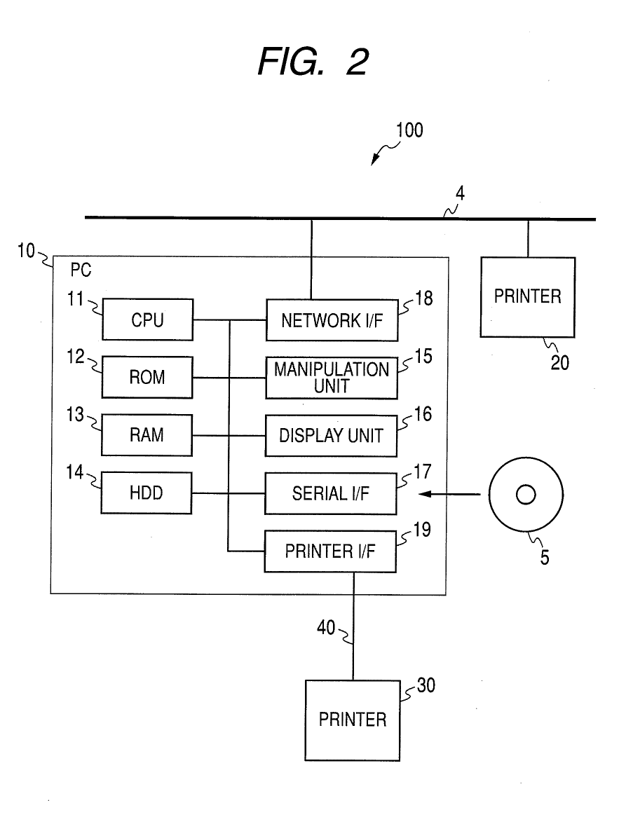

Specifically, as shown in FIG. 2, the PC 10 includes a CPU 11 performing various calculation processes, a ROM 12 storing activating programs (BIOS) performed by the CPU 11 at the time of activating the PC 10, a RAM 13 used as a temporary memory area at the time of allowing the CPU 11 to perform various processes, and a hard disk drive (HDD) 14 storing various programs or data.

The PC 10 further includes a manipulation unit 15 including a keyboard and a mouse, a display unit 16 including a liquid crystal display, etc., a serial port interface 17 exchanging signals with other information devices such as a CD-ROM drive, a network interface 18 exchanging signals through a network such as a LAN and Internet, and a printer port interface 19 exchanging signals with the printers.

An operation System (OS), printer drivers controlling the printers 20 and 30, and various applications such as a word processor and spreadsheet software are installed in the HDD 14 of the PC 10. As a function of the OS installed therein, a default printer can be set.

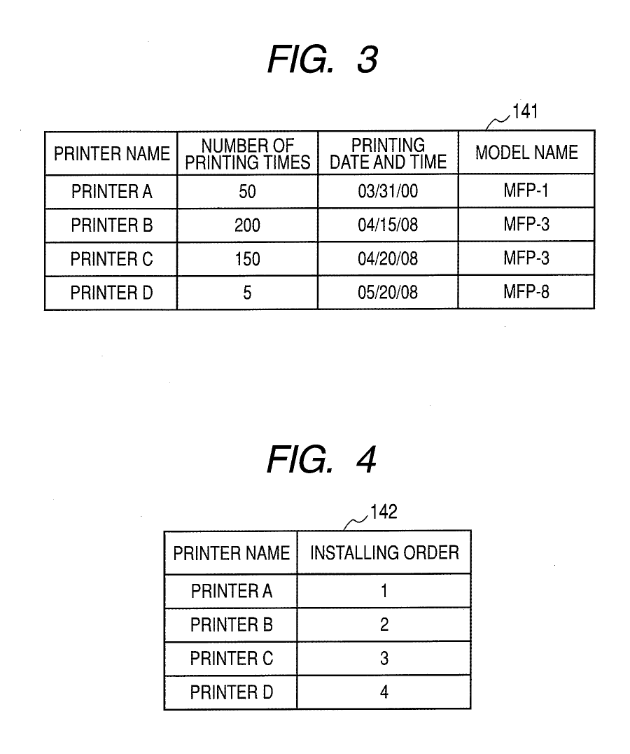

The HDD 14 of the PC 10 includes a database 141 storing a history of utilizing printers and a database 142 storing a history of setting printers as a default printer. Specifically, as shown in FIG. 3, printer names for identifying the printers, the number of printing times, printing dates and times, and printer model names are stored in the database 141. As shown in FIG. 4, printer names for identifying the printers and installing order of the printers are stored in the database 142.

The number of print job processing times in the corresponding printer is recorded in the “number of printing times” and the final printing date and time of the corresponding printer is recorded in the “printing date and time”, in the database 141. The order of the printer driver installed in the PC 10 is recorded in the “installing order” in the database 142, where a greater number means a newer installed printer driver. These days, a printer driver is automatically set to a default printer at the time of installing the printer driver. Accordingly, the installing order can be considered as an order in which it is set as the default printer. Hereinafter, the “number of printing times” and the “printing date and time” are referred to as a “print history” and the “installing order” is referred to as a “default history.”

The print history in the database 141 is added or updated by the printer drivers every printing process. That is, the printer driver newly registers a printer when the corresponding printer is not registered in the database 141 after performing a printing process. On the other hand, when the printer is registered, 1 is added to the “number of printing times” and the print end time is recorded in the “printing date and time.” A monitoring program may add or update the print history in the database 141 instead of the printer driver. The default history in the database 142 is added or deleted every installation or uninstallation.

(Operation of Installer)

Now, an operation of the installer of the installer system 100 will be described. The installer installs a printer driver to be installed and also uninstalls a printer driver selected by a user. In the followings, four embodiments having different methods of extracting a printer driver to be uninstalled will be described.

The installer is stored in the CD-ROM 5 (see FIG. 2) and is executed through the serial interface 17 of the PC 10. The installer may be downloaded from a server of a maker through the Internet or may be stored in a recording medium other than the CD-ROM 5.

### First Embodiment

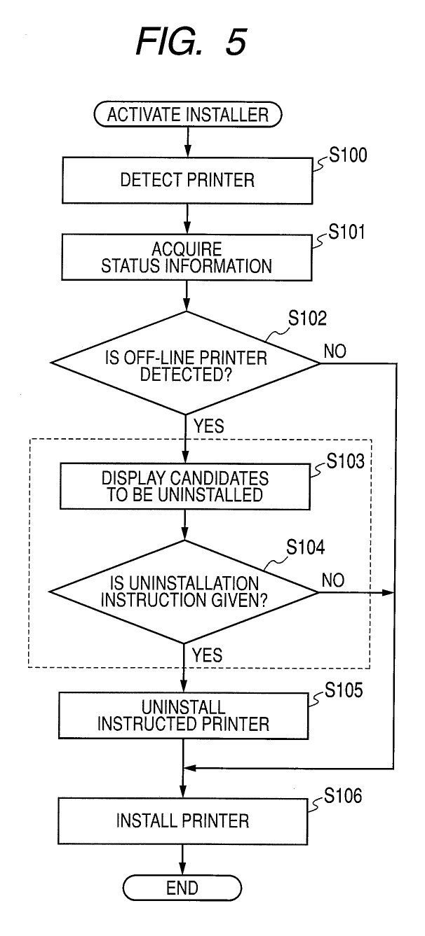

An installer operation according to a first embodiment will be described now with reference to the flowchart shown in FIG. 5. The installer according to the first embodiment extracts a printer driver to be uninstalled on the basis of the printers' statuses. That is, when a printer is in an off-line status, it can be determined that the utilization frequency of the printer is lower or the non-utilization possibility of the printer is higher than that of a printer in an on-line status.

Therefore, first, the installed printers in the PC 10 are detected (S100). Then, the statuses of the detected printers are acquired (S101). Thereafter, it is determined whether a printer in the off-line status is detected (S102). When a printer in the off-line status is not detected (NO in S102), the process of S106 is performed, the printer driver to be installed is installed (S106), and the procedure is ended.

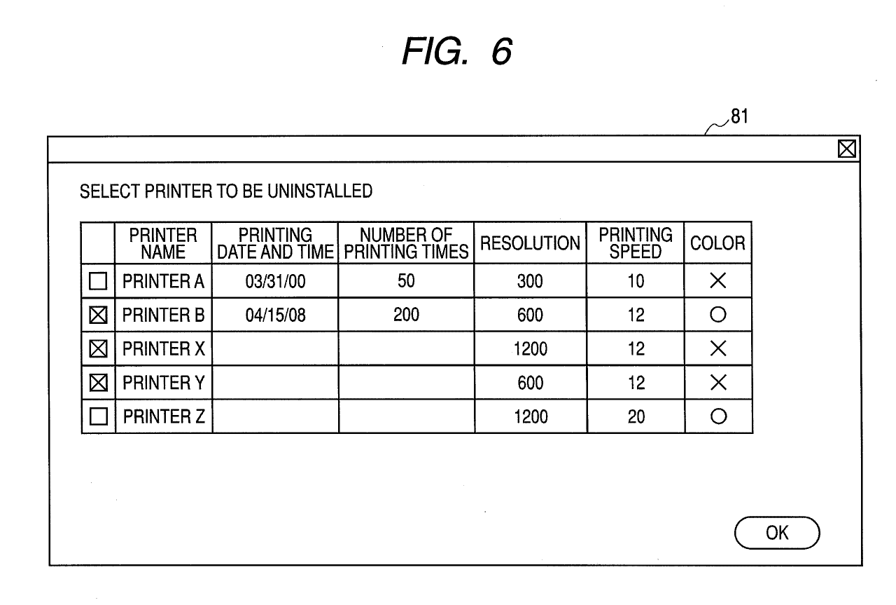

On the other hand, when a printer in the off-line status is detected (YES in S102), the detected printer in the off-line status is displayed in a list on the display unit 16 (S103). For example, a dialog 81 shown in FIG. 6 is displayed and the detected printer in the off-line status is displayed in a list to select the printer driver to be uninstalled. In the dialog 81, the printer of which a check box in the left column of the list is marked by “X” is set to be uninstalled. When the number of detected printers in the off-line status is plural, all the printers are displayed. By setting the plural printer drivers as printer drivers to be uninstalled and displaying the printer drivers to be uninstalled in the list, the user's degree of freedom in selection is increased.

When the dialog 81 is displayed, if the printer driver to be uninstalled is registered in the database 141, the number of printing times and the printing date and time of the printer, which corresponds to the print history, are displayed together with the printer name. If the specification of the printer can be acquired from the printer name, the acquired specification is displayed together with the printer name. The information serves as a reference for selecting a printer driver to be uninstalled. Since the printers are displayed in the list, it is possible to easily compare the printers. Therefore, it is possible to prevent the user's misjudgment.

It is then determined whether an instruction for uninstallation is given (S104). The instruction for uninstallation is given by allowing the user to select the printer to be uninstalled from the printers displayed in the list and to press an OK button. On the other hand, when the OK button is pressed in the state where the printer to be uninstalled is not selected, it is considered that the instruction for uninstallation is not given. When the instruction for uninstallation is not given (NO in S104), the printer driver to be installed is installed (S106) and the procedure is ended.

On the other hand, when the instruction for uninstallation is given (YES in S104), the printer which it is instructed to uninstall is uninstalled (S105). Accordingly, a desired printer driver is deleted in accordance with the user's judgment.

Thereafter, the printer driver to be installed is installed (S106). In the installing process, the printer driver to be installed is installed in the PC 10 and the printer to be installed is set as a default printer of the PC 10. A record of the printer is added to the database 142. After the installing process of S106, the procedure is ended.

The installer according to the first embodiment provides the user with the opportunity to uninstall the existing printer drivers before installing the printer driver to be installed. Therefore, it is possible to suppress the number of printer drivers from increasing. The printer in the off-line status is set to be uninstalled, but the printer in the on-line status is not set to be uninstalled. Accordingly, it can be made to operate in accordance with the user's necessity.

In this embodiment, it is inquired of the user whether the printers should be uninstalled after detecting the printers in the off-line status, but the printers may be automatically uninstalled without inquiry. In this case, the list displaying process (S103) and the uninstallation target selecting process (S104) (that is, in the broken line in FIG. 5) are bypassed and all the detected printers are uninstalled. By automatically uninstalling the printers, it is possible to reduce the user's labor at the time of installation. After the automatic uninstallation, it may be notified that the uninstalled printers exist. On the other hand, by checking and uninstalling the uninstallation target, it is possible to enhance the user's degree of freedom in selection.

### Second Embodiment

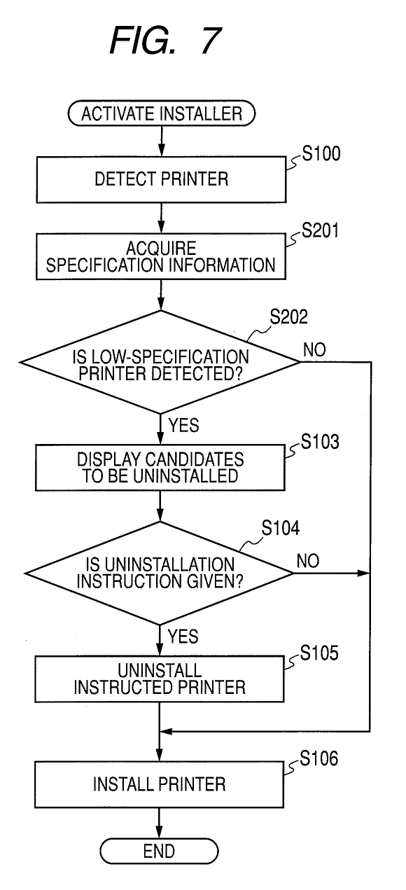

An operation of an installer according to a second embodiment will be described now with reference to the flowchart shown in FIG. 7. The installer according to the second embodiment extracts a printer driver to be uninstalled on the basis of a specification of a printer. That is, when the specification of a printer is lower than the specification of the printer to be installed, it can be considered that the utilization frequency of the printer will be lowered or the printer will not be used after the printer to be installed is installed.

Therefore, the installed printers in the PC 10 are detected (S100) and specification information of the detected printers is acquired (S201). The specification information includes, for example, a resolution, a printing speed, and color/monochrome information. The acquired specification information may be one or two or more. The specification information is recorded in the CD-ROM 5 and can be acquired by accessing the specification information on the basis of model names of the printers.

It is then determined whether a printer having a lower specification than that of the printer to be installed is detected (S202). Here, in a case where the specification information includes plural specification information pieces, when at least one of the specification information pieces is lower than that of the printer to be installed, the corresponding printer is detected as the printer to be uninstalled. When a printer having a lower specification than that of the printer to be installed is not detected (NO in S202), the printer driver to be installed is installed (S106) and the procedure is ended.

On the other hand, when a printer having a lower specification than that of the printer to be installed is detected (YES in S202), the detected low-specification printer is displayed in a list on the display unit 16 (S103). Only the detected printers are displayed on the display unit 16 and the printer to be uninstalled is selected from the printers displayed in the list (S104). The printer which it is instructed to uninstall is uninstalled (S105). Thereafter, the printer driver to be installed is installed (S106) and the procedure is ended.

In the installer according to the second embodiment, a low-specification printer is set to be uninstalled but a high-specification printer is not set to be uninstalled. Accordingly, it can be made to operate in accordance with the user's necessity.

In the second embodiment, when a printer has at least one low-specification information piece at the time of detecting the printers in the process of S202, the printer is set to be uninstalled. However, only when all specification information of a printer is low, the printer may be set to be uninstalled.

### Third Embodiment

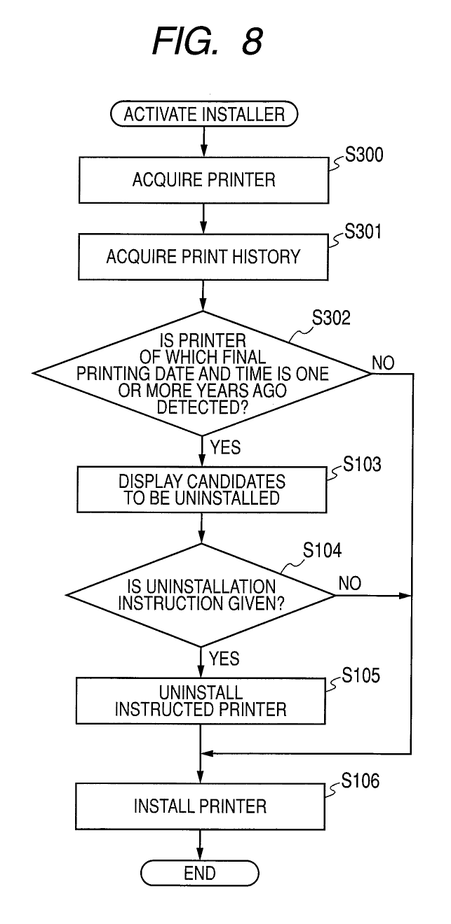

An operation of an installer according to a third embodiment will be described now with reference to the flowchart shown in FIG. 8. The installer according to the third embodiment extracts a printer driver to be uninstalled on the basis of a print history of a printer. That is, when it is a predetermined time (for example, one or more years) ago to finally use a printer (the final printing date and time of a printer is a predetermined time ago), it can be considered that the utilization frequency of the printer is very low or the printer is not used at all.

Therefore, first, the printers registered in the database 141 are acquired (S300) and the final printing date and time of each of the printers is acquired (S301). In this embodiment, since the printers are acquired from the database 141, a printer to be uninstalled is extracted from the printers registered in the database 141.

It is then determined whether a printer of which the final printing date and time is one or more years ago is detected (S302). When the printer of which the final printing date and time is one or more years ago is not detected (NO in S302), the printer driver to be installed is installed (S106) and the procedure is ended.

On the other hand, when the printer of which the final printing date and time is one or more years ago is detected (YES in S302), the detected printer is displayed in a list on the display unit 16 (S103). Only the detected printers are displayed on the display unit 16 and the printer to be uninstalled is selected from the printers displayed in the list (S104). The printer which it is instructed to uninstall is uninstalled (S105). Thereafter, the printer driver to be installed is installed (S106) and the procedure is ended.

In the installer according to the third embodiment, a printer not used for one or more years is set to be uninstalled but a printer once used within one year is not set to be uninstalled. Accordingly, it can be made to operate in accordance with the user's necessity.

In addition to the final printing date and time, the number of printing times may be used as the print history. For example, when the number of printing times is equal to or less than a predetermined value (for example, 10 or less), the corresponding printer may be set to be uninstalled. The default history may be acquired from the database 142 and the printer to be uninstalled may be determined on the basis of the installing order (for example, printers other than three latest printers in the installing order may be set to be uninstalled).

In this embodiment, the databases 141 and 142 manage the print history and the default history. However, when the histories can be managed by the OS, the histories may be acquired from the OS.

### Fourth Embodiment

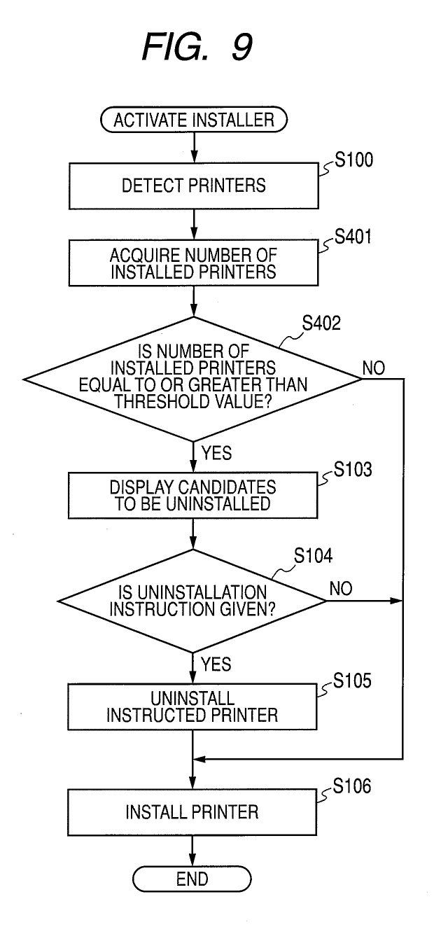

An operation of an installer according to a fourth embodiment will be described now with reference to the flowchart shown in FIG. 9. The installer according to the fourth embodiment extracts a printer driver to be uninstalled on the basis of the number of installed printer drivers. That is, when the number of printers is equal to or greater than a predetermined value, it can be considered that the choice of printers for use is various and thus the operability is deteriorated. In other words, when the number of printers is small, it can be considered that it hardly influences the operability.

Therefore, first, the installed printers in the PC 10 are detected (S100) and the number of detected printers is acquired (S401). Then, it is determined whether the number of printers is equal to or greater than a threshold value (S402). When the number of printers is smaller than the threshold value (NO in S402), a printer driver to be installed is installed (S106) and the procedure is ended.

On the other hand, when the number of printers is equal to or greater than the threshold value (YES in S402), all the printers detected in the process of S100 are displayed in a list on the display unit 16 (S103). Only the detected printers are displayed on the display unit 16 and the printer to be uninstalled is selected from the printers displayed in the list (S104). The printer which it is instructed to uninstall is uninstalled (S105). Thereafter, the printer driver to be installed is installed (S106) and the procedure is ended.

The installer according to the fourth embodiment inquires whether any printer should be uninstalled when the number of installed printers is great and does not inquire whether any printer should be uninstalled when the number of installed printers is small. Accordingly, when the number of installed printers is small, the user's labor at the time of installation is reduced.

As described above in detail, the installer of the installer system 100 according to this embodiment extracts a printer driver to be uninstalled from the installed printer drivers under a predetermined condition (status, specification, printing date and time, the number of printer drivers, and the like) and inquires of the user whether the extracted printer driver should be uninstalled. The printer driver is uninstalled in accordance with the user's instruction. Accordingly, the installer can install the printer driver to be installed and can uninstall the installed printer driver. Therefore, it is possible to suppress the number of printer drivers from increasing. As a result, it is possible to accomplish excellent operability in using a printer.

The above-mentioned embodiments are only an example and thus do not limit the invention. Accordingly, the invention can be improved or modified in various forms without departing from the gist of the invention. For example, printers are installed or uninstalled in the embodiments, but the invention is not limited to the printers. That is, the invention may be applied to a device such as a scanner controlled by information apparatuses such as PC. The printer drivers are installed in the PC in the embodiments, but the invention is not limited to the PC. For example, the printer drivers may be installed in a work station or a mobile information terminal.

In the embodiment, the “installing order” which is the utilization history as a default device is stored in the database 142 and the “number of printing times” and the “printing date and time” which are the device utilization record are stored in the database 141, but the invention is not limited to them. For example, “resolution”, “printing speed”, and “color correspondence” which are the device specification information may be recorded therein.

The specification information is acquired from the CD-ROM 5 in the embodiments, but the invention is not limited to the embodiments. For example, the specification information may be stored in a web server and the server may be accessed at the time of acquiring the specification information. When the specification information is stored in the OS, the specification information may be acquired from the OS. Alternatively, the specification information may be recorded in the installer and the necessary specification information may be acquired therefrom.

In the above-mentioned embodiments, only the printers detected under a predetermined condition (off-line, specification, and the like) are displayed at the time of displaying the printers to be uninstalled in a list. However, all the printers may be displayed. If all the printers are displayed, the detected printers and the non-detected printers may be displayed distinctly. For the distinction, one-side printers may be inverted or the font thereof may be changed.

The above-mentioned four embodiments may be combined. For example, at the time of performing the uninstallation process according to the fourth embodiment, the printer to be uninstalled may be extracted on the basis of one of the first to third embodiments before performing the process of S103.

While the present invention has been shown and described with reference to certain exemplary embodiments thereof, it will be understood by those skilled in the art that various changes in form and details may be made therein without departing from the spirit and scope of the invention as defined by the appended claims.

According to an aspect of the invention, the device driver to be uninstalled is extracted from the installed device drivers, and it is inquired of the user whether the extracted device driver should be uninstalled. The extracted device driver is uninstalled in accordance with the user's instruction. Accordingly, it is possible to install a device driver to be installed and to uninstall the installed device driver. Therefore, it is possible to prevent the number of device drivers from increasing.

When the number of installed device drivers is great, the operability may be deteriorated. In other words, when the number of installed device drivers is small, there is no problem in many cases. Therefore, according to an aspect of the invention, the uninstalling process is inquired when the number of device drivers is greater than a predetermined value and the uninstalling process is not inquired when the number of device drivers is smaller than the predetermined value. As a result, it is possible to reduce the user's labor at the time of installation.

According to an aspect of the invention, at the time of selecting a device driver to be uninstalled, the specific information (specification or utilization history) serves as a reference for selection. Accordingly, it is possible to prevent the user's misjudgment.

According to an aspect of the invention, by setting plural device drivers as device drivers to be uninstalled, the user's degree of freedom in the selection of the device driver is increased.

According to an aspect of the invention, by preferentially setting a device driver of a low-specification device as a device driver to be uninstalled, it can be made to operate in accordance with the user's necessity of the device. For example, in a case where the devices are printers, a printing speed, a resolution, and an error generation rate can be used as the indicator.

According to an aspect of the invention, by preferentially setting a device driver of a device in the off-line state as a device driver to be uninstalled, it can be made to operate in accordance with the user's necessity of the device.

According to an aspect of the invention, at the time of installation, the device driver satisfying a predetermined condition (an off-line status, a low specification, and the like) is automatically uninstalled. Accordingly, the user's labor for confirmation is reduced at the time of installation.

What is claimed is:

1. An installer system comprising:
a detection unit configured to detect at least one device driver having been installed in a computer, in response to an installation instruction to install a device driver to be installed;
an output unit configured to set at least one of the device driver detected by the detection unit as at least one device driver to be uninstalled, and configured to output a screen for displaying information on the device driver to be uninstalled, the screen to which an uninstallation instruction can be input; and
an uninstaller unit configured to uninstall the device driver to be uninstalled in response to the uninstallation instruction.

2. The installer system according to claim 1,
wherein when the number of the device driver detected by the detection unit is equal to or greater than a threshold value, the output unit outputs the screen.

3. The installer system according to claim 1,
wherein the screen displays specific information on at least one device corresponding to the device driver to be uninstalled.

4. The installer system according to claim 1,
wherein the at least one device driver, detected by the detection unit, includes a plurality of device drivers,
wherein the output unit sets the plurality of device drivers as device drivers to be uninstalled,
wherein the screen displays information on the device drivers to be uninstalled, and
wherein at least one of the device drivers to be uninstalled can be selected.

5. The installer system according to claim 1,
wherein the output unit sets the device driver, detected by the detection unit, of at least one device having a specification lower than a specification of a device corresponding to the device driver to be installed as the device driver to be uninstalled.

6. The installer system according to claim 1,
wherein the output unit sets the device driver, detected by the detection unit, of at least one device being in an off-line as the device driver to be uninstalled.

7. The installer system according to claim 1, further comprising:
a extraction unit configured to extract at least one device driver satisfying a condition from the device driver detected by the detection unit; and
an automatic uninstaller unit configured to uninstall the device driver extracted by the extraction unit.

8. An installer system, comprising:
a detection unit configured to detect at least one device driver having been installed in a computer, in response to an instruction to install a device driver to be installed;
an extraction unit configured to extract at least one device driver from the device driver detected by the detection unit, under a condition; and
an automatic uninstaller unit configured to uninstall the device driver extracted by the extraction unit.

9. A computer-readable medium having a computer program stored therein and readable by a computer, the computer program, when executed by the computer, causing the computer to perform operations comprising:
detecting at least one device driver having been installed in the computer, in response to an installation instruction to install a device driver to be installed;
setting at least one of the device driver detected by the detection unit as at least one device driver to be uninstalled;
outputting a screen for displaying information on the device driver to be uninstalled, the screen to which an uninstallation instruction can be input; and
uninstalling the device driver to be uninstalled in response to the uninstallation instruction.

10. A computer-readable medium having a computer program stored therein and readable by a computer, the computer program, when executed by the computer, causing the computer to perform operations comprising:
detecting at least one device driver having been installed in the computer, in response to an instruction to install a device driver to be installed;
extracting at least one device driver from the device driver detected by the detection unit, under a condition; and
uninstalling the device driver extracted by the extraction unit.
